(19) United States
(12) Patent Application Publication
(10) Pub. No.: US 2024/0399987 A1
(43) Pub. Date: Dec. 5, 2024

(54) ROLL-FORMED VEHICLE STRUCTURAL BEAM WITH REINFORCING INSERT

(71) Applicant: Shape Corp., Grand Haven, MI (US)

(72) Inventors: Doug Witte, Grand Haven, MI (US); Jeffrey A. McHenry, Norton Shores, MI (US)

(73) Assignee: Shape Corp., Grand Haven, MI (US)

(21) Appl. No.: 18/678,985

(22) Filed: May 30, 2024

Related U.S. Application Data
(60) Provisional application No. 63/504,941, filed on May 30, 2023.

(51) Int. Cl. B60R 19/04; B60R 19/02; B60R 19/18

(52) U.S. Cl. CPC B60R 19/04; B60R 19/023; B60R 2019/1813

(57) ABSTRACT

A reinforcement beam for a vehicle has an outer beam profile and a reinforcing insert introduced during the roll-forming process. The outer beam profile defines an elongated hollow body and includes a front wall portion and a rear wall portion. The outer beam profile may include upper and lower flanges formed in planar extension of the font wall portion. The reinforcing insert may define an upper shear wall and a lower shear wall that each extend between the front wall portion and the rear wall portion. The reinforcing insert may be introduced to a partial profile in a roll-forming process through an automated operation. The reinforcing insert may be present over a central section of the elongated hollow body and have a length that is less than half the length of the elongated hollow body.

### CROSS-REFERENCE TO RELATED APPLICATION

This application claims the benefit and priority under 35 U.S.C. § 119 (e) of U.S. provisional application Ser. No. 63/504,941, filed on May 30, 2023, the content of which is incorporated herein by reference in its entirety.

### TECHNICAL FIELD

The present disclosure relates generally to structural beams for vehicles, such as roll-formed bumper structural beams having reinforcing inserts for structural applications, including bumper assemblies, subassemblies, and components thereof.

### BACKGROUND

Vehicle bumper systems commonly include at least one structural beam that spans across the front or rear end of the vehicle. The primary structural beam is typically supported by crush cans that attach to the vehicle frame structure. Vehicle bumper systems undergo rigorous testing for impact energy management and absorption from high speed and low speed crash impacts, such as to comply with mandated government regulations and insurance certifications. For example, impact requirements and protocols for bumper systems are set forth by the United States Federal Motor Vehicle Safety Standards (US FMVSS), the Insurance Institute for Highway Safety (IIHS), the National Highway Traffic Safety Administration (NHTSA), the European EC E42 consumer legislation, and the Asian Pedestrian Protection for lower and upper legs, among others. Bumper systems are also designed to maximize strength-to-weight ratios in an effort to minimize the overall vehicle weight, while balancing the cost of the associated bumper system components. Conventional bumper structural beams may involve multiple, separately formed components, which increases manufacturing time and costs.

### SUMMARY

This disclosure provides a structural beam for a vehicle that functions to receive and absorb impact loads received from vehicle collisions, such as implementations of a vehicle bumper beam. The structural beam includes a roll-formed outer beam profile having an elongated hollow body formed from a sheet material. The hollow body has a front wall portion and a rear wall portion extending along a length defined between a first end and a second end of the hollow body. A reinforcing insert is disposed in the hollow body along a central section of the reinforcement beam between first and second lateral end sections. The reinforcing insert has an upper wall and a lower wall that each extend between the front wall portion and the rear wall portion of the outer beam profile. The reinforcing insert is disposed in the outer beam profile during the roll-forming process.

The reinforcing insert of the structural beam may further include an intermediate wall disposed between the upper wall and the lower wall. The intermediate wall may be disposed adjacent the front wall portion. The intermediate wall of the reinforcing insert may be welded to the front wall portion of the outer beam profile. The upper and lower walls of the reinforcing insert may extend rearward at an angle of between 70° and 90° relative to the front wall portion. The upper wall of the reinforcing insert portion may extend rearward and upward at an angle of greater than 75° relative to the front wall portion. The lower wall may extend rearward and downward at an angle of less than 75° relative to the front wall portion. The upper and lower walls of the reinforcing insert may divide interior volume of the hollow body to form a plurality of elongated hollow areas.

The central section of the structural beam may have a first length, and the first and second lateral end sections may have respective second and third lengths. The first length may be less than the sum of the second and third lengths. The first length may be equal to the second length and to the third length.

The outer beam profile may comprise a top wall portion and a bottom wall portion. The top wall portion and bottom wall portion may extend between the front wall portion and the rear wall portion. The outer beam profile may include an upper flange at a junction of the front wall portion and the top wall portion, and/or a lower flange at a junction of the front wall portion and the bottom wall portion. The upper flange and the lower flange may include zero-thickness bends. The zero-thickness bends may be annealed during the roll-forming process.

One aspect of the disclosure provides a bumper beam that is configured to be supported by crush cans at a vehicle frame. The rear wall portion may include an attachment surface that is adapted for attachment to crush cans. The bumper beam includes a roll-formed outer beam profile having an elongated hollow body formed from a sheet material. The hollow body has a front wall portion and a rear wall portion extending along a length defined between a first end and a second end of the hollow body. The bumper beam includes a reinforcing insert disposed along a central section of the hollow body between first and second lateral end sections. The reinforcing insert has an upper wall and a lower wall that each extend between the front wall portion and the rear wall portion of the outer beam profile. The reinforcing insert is disposed in the outer beam profile during the roll-forming process. The bumper beam may include any one or a combination of the features described with respect to the structural beam.

One aspect of the disclosure provide a method of forming a structural beam for a vehicle. The method includes roll-forming a partial profile. The method includes inserting a reinforcing insert into the partial profile. The method includes roll-forming the partial profile including the reinforcing insert into an outer beam profile of a structural beam for a vehicle, where the structural beam has an elongated hollow body. The structural beam of the method may include any one or a combination of the features described above. The step of inserting the reinforcing insert may be performed by an automated process. The automated process may be performed by a robotic manipulator.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a schematic side elevation view of a vehicle having a bumper assembly including a structural beam including a reinforcing insert.

FIG. 2 is a schematic side elevation view of the structural beam and the supporting crush can of FIG. 1.

FIG. 3 is a front elevation view of the structural beam of FIGS. 1-2.

FIG. 4 is a schematic perspective view of the structural beam of FIGS. 1-3

FIG. 5 is a schematic diagram of an exemplary roll-forming process manufacturing line useable for fabricating a structural beam including a reinforcing insert.

FIG. 6 is a schematic side elevation view of a partially manufactured structural beam including a reinforcing insert.

FIG. 7 is a transverse cross-sectional view of an exemplary structural beam.

FIG. 8 is a transverse cross-sectional view of a second exemplary structural beam.

FIG. 9 is a transverse cross-sectional view of a third exemplary structural beam.

FIG. 10 is a transverse cross-sectional view of a fourth exemplary structural beam.

FIG. 11 is a transverse cross-sectional view of a fifth exemplary structural beam.

FIG. 12 is a transverse cross-sectional view of a sixth exemplary structural beam.

FIG. 13 is a transverse cross-sectional view of a seventh exemplary structural beam.

FIG. 14 is a transverse cross-sectional view of an eighth exemplary structural beam.

FIG. 15 is a transverse cross-sectional view of a ninth exemplary structural beam.

FIG. 16 is a transverse cross-sectional view of a tenth exemplary structural beam.

Like reference numerals indicate like parts throughout the drawings.

### DETAILED DESCRIPTION

Structural beams including a reinforcing insert for vehicle structures, such as vehicle bumper structure or vehicle frame structures, are disclosed herein in various implementations as impact energy absorption and management devices that are used in conjunction with other vehicle components to absorb and manage impact loads and energy so as to minimize damage and intrusion during an impact to the vehicle. For example, a structural beam may be employed at a bumper assembly that is attached to a vehicle frame, where the structural beam is a cross car structure supported by crush cans. In some instances, vehicle bumper assemblies can have increased front end stiffness and impact energy absorption requirements, such as on electric vehicles or rear engine mounted vehicles with greater vehicle mass and front ends that may be more susceptible to impact intrusion. While it is generally known that bumper structural beams with increased mass can function to meet increased stiffness requirements, increasing mass typically adds to the vehicle cost while also reducing efficiency. Structural beams disclosed herein may provide increased stiffness being formed, for example by roll forming, of a single sheet of metal or other rigid material with a reinforcing insert.

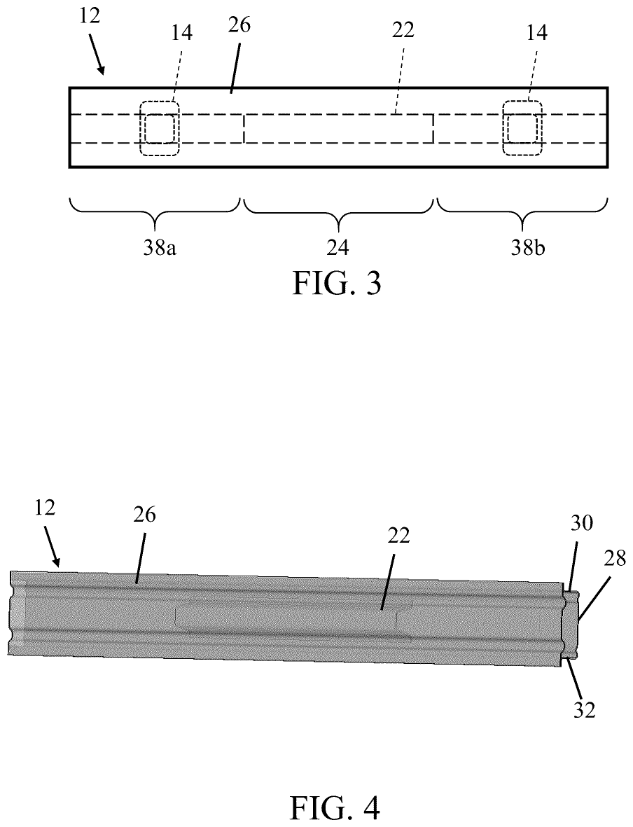

Referring now to the drawings and the illustrative examples depicted therein, a bumper assembly 10 for a vehicle 100, is provided. The structural beam 12 includes an outer beam profile 20 and a reinforcing insert 22 that reinforces a central section 24 (FIG. 3) of the structural beam 12. The outer beam profile 20 defines an elongated hollow body formed from a sheet material, such as a metal sheet material, and may include a front wall portion 26 and a rear wall portion 28. The front wall portion 26 and rear wall portion 28 may be connected by a top wall portion 30 and a bottom wall portion 32. The front wall portion 26, rear wall portion 28, top wall portion 30 and bottom wall portion 32 together define the outer beam profile 20 and the elongated hollow body.

The metal sheet material of the structural beam 12 can comprise any metals or metal alloys that have the desired characteristics, such as stiffness, tensile strength, and the like. For example, the material may include aluminum or steel, such as a high strength or ultra-high strength steel, as well as combinations of other related metals in different alloys. The sheet material may be entirely or partial a non-sheet material, such as an injection molded polymer, a composite, an aluminum extrusion, or a composite pultrusion, or the like. The sheet material of the outer beam profile 20 may be formed in various processes, such as with the use of cold stamping, roll forming, roll stamping, hot stamping, press brake bending, or combinations thereof. References herein to a particular forming process should be understood as non-limiting. Selection of the appropriate forming process for a particular material and application of the presently disclosed structural beam 12 may be understood as within the level of ordinary skill.

The metal sheet material may comprise a single material thickness throughout the outer beam profile 20 and the reinforcing insert 22. Alternatively, the metal sheet material may have variable thickness. For example, the metal sheet material forming the outer beam profile 20 may comprise a first thickness and the metal sheet material forming the reinforcing insert 22 may comprises a second thickness that is different from the first thickness. The first thickness may be thinner than the second thickness. The first thickness may be thicker than the second thickness. When the structural beam 12 is implemented as a bumper reinforcement beam, it may be desirable for the first thickness to be thinner than the second thickness to provide easier deformation in side or corner impacts, as the second thickness being thicker provides greater resistance to deformation to straight-on collisions. Alternatively, the first thickness may be thicker than the second thickness when the structural beam 12 is implemented as a side beam of a battery tray to provide strength reinforcement without additional weight increase. In one example, the sheet material first thickness of the outer beam profile 20 may be approximately 1 mm, and the sheet material second thickness of the reinforcing insert 22 may be approximately 2 mm. In additional examples, the reinforcing insert 22 may be greater than about 1.2 mm, greater than 1.5 mm, or greater than about 1.8 mm when the outer beam profile 20 is about 1 mm.

The reinforcing insert 22 reinforces a hollow interior area 44 between the front wall portion 26 and the rear wall portion 28 of the outer beam profile 20 by providing an upper wall 34 and a lower wall 36 that each extend between the front wall portion 26 and rear wall portion 28. The upper wall 34 and the lower wall 36 may be separated by an intermediate wall 33. The intermediate wall 33 may be disposed adjacent the front wall portion 26. The several wall portions may be formed integrally with each other by bending operations or in a roll-forming process. The upper and lower walls 34, 36 may also be referred to as shear walls and may be configured to undergo axial loading, for example, from impact forces to the bumper system where the structural beam 12 is used in a vehicle bumper assembly.

The outer profile 20 may include one or more sets of ribs 37. The ribs 37 formed in the rear wall portion 28 may be formed to abut an end section of the upper and lower walls 34, 36 of the reinforcing insert 22. The ribs 37 may assist in the controlled deformation of the structural beam 12 during impact loading. Other ribs 27 may be formed in the front wall portion to act as strengthening features or crush initiators. The ribs 27, 37 may extend continuously along the front wall portion 26 and rear wall portion 28 respectively, or may be discontinuous and occur only at discrete limited points along the length of the structural beam 12. The ribs 27, 37 may be angled, curved, or flattened depressions extending inwardly of the hollow interior area 44.

The upper and lower walls 34, 36 of the reinforcing insert 22 may divide the hollow interior area 44 of the hollow body formed by the outer beam profile 20 to form a plurality of elongated hollow areas 44′, 44″, 44′″ (FIG. 2). In doing so, the reinforcing insert 22 may be configured such that ribs in the front wall portion 26 may be generally centered over the respective upper and lower hollow areas 44′, 44′″. The upper and lower walls 34, 36 of reinforcing insert 22 may extend rearward at an angle α relative to the front wall portion 26. In some examples, the angle α is 90°, and the upper and lower walls 34, 36 are perpendicular to the front wall portion 26. In other examples, the upper and lower walls 34, 36 extend at an angle less than 90°, such as about 70° inclined away from each other. In other examples, the angle α for the upper wall 34 of reinforcing insert 22 extends rearward and upward at between 75° and 90° relative to the front wall portion 26. In some examples, the angle α for the lower wall 36 extends rearward and downward at an angle of between 75° and 90° relative to the front wall portion 26. It is also contemplated that the angle may be 78°, between 78° and 80°, between 78° and 82°, between 75° and 85°, between 75° and 90°, between 70° and 95°, or other suitable range.

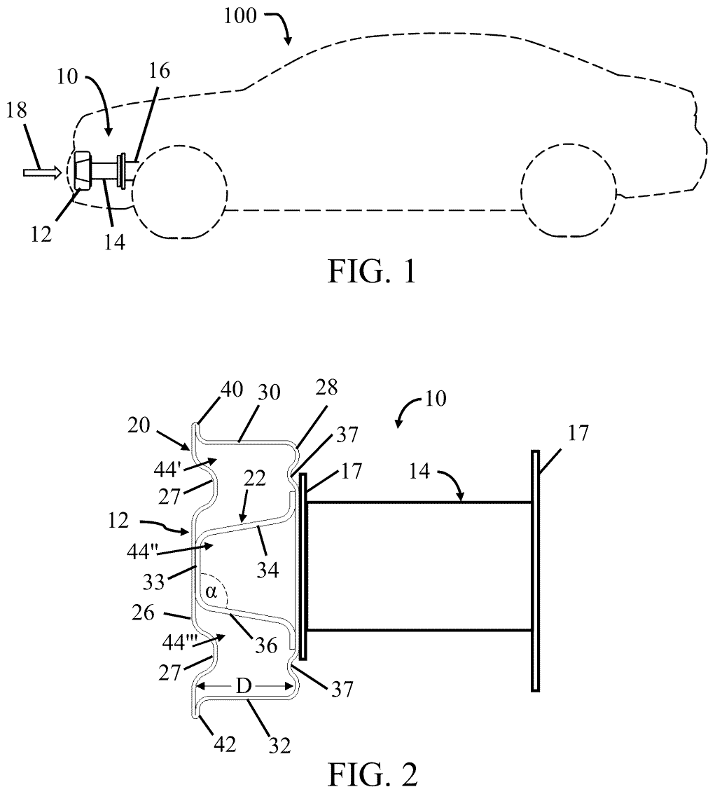

The reference to front and rear and other directional derivatives for this example of the reinforcement beam is in reference to its use on a front bumper assembly (FIG. 1) and its relative location on the associated vehicle 100; however, it is understood that the structural beam 12 disclosed herein may also be used on a rear bumper assembly or a side frame structure, such as a rocker or a battery tray side member, among other conceivable uses on a vehicle structure or subassembly to absorb and manage impact loads and energy. Consistent with the present disclosure, the reference to front may refer to the aspect proximate to the point of force application, but this is not intended to be limiting and the relative geometry may be reversed.

As shown in FIG. 1, the structural beam 12 is supported by crush cans 14 that are attached to the structural beam 12 at generally equal spacing from a center of the structural beam 12. The crush cans 14 of the bumper assembly 10 each mount to an end or tip of a frame rail 16 or other supportive portion of a vehicle frame to position the structural beam 12 so that it spans laterally (in a width direction of the vehicle) across a front end of the vehicle 100. As shown in FIG. 1, the bumper assembly 10 is mounted at the front end of the vehicle 100, which may be a passenger vehicle or other type of motor vehicle, such as a car, truck, bus, van, sport utility vehicle or the like. The crush cans 14 functions to support the structural beam 12 at the vehicle frame 16 and to direct and absorb impact loads 18 received (in a longitudinal or x-direction relative to the vehicle) from the supported structural beam 12 to the attached frame 16 through the crush cans 14. It is also contemplated that the bumper assembly 10 and other implementations thereof may be used or otherwise incorporated into a rear end of a vehicle. Alternatively, the structural beam 12 may be applied as a side frame structure, such as a rocker, or a battery tray side member, among other conceivable uses on a vehicle structure or subassembly.

As shown for example in FIG. 2, a structural beam 12 and crush can 14 are illustrated. The crush can 14 is formed as a thin-walled, hollow structure that is a frangible structure designed to crush to absorb impact energy received at the structural beam 12 in a vehicle collision. The bumper assembly 10 may include one or more attachment plates 17 between the crush can 14 and the structural beam 12 or between the crush can 14 and the vehicle frame component 16 (FIG. 1), or both. The one or more attachment plates 17 may include a distribution of apertures for attachment to the structural beam 12 or the vehicle frame component 16 with threaded or similar fasteners, such as bolts, rivets, or the like. The crush can 14 may be welded to the one or more attachment plates 17. Alternatively, the crush can 14 may be welded directly to the structural beam 12, or to the vehicle frame component 16, or both.

As further shown in FIGS. 2-4, the reinforcing insert 22 of the structural beam 12 reinforces a central section 24 of the outer beam profile 20. The reinforcing insert 22 has a length between its opposing ends that may be less than a half of the length of the outer beam profile 20. For example, the length of the outer beam profile 20 may be between approximately 800-1,200 mm, such as 1,000 mm, and the length of the reinforcing insert 22 may be between approximately 300-600 mm, such as 400 mm. The top wall portion 30 and bottom wall portion 32, spanning between the front wall portion 26 and rear wall portion 28, provide a depth D to the outer beam profile 20. The depth D of the section may be constant along the length of the structural beam 12, and may be generally proportional to the other features. In the example illustrated, where the length is 1,000 mm, the depth is approximately 40 mm and in additional examples may be 50-70 mm or more or less. In other alternatives, the depth D may not be constant along the entire length of the structural beam 12. For example, the depth D may be greater in the central section 24 where the reinforcing insert 22 is present and may be smaller in the lateral end sections 38a, b. In a further alternative, the depth D may taper, varying continuously along the lateral end sections 38a, b from the central section 24 to the outer ends.

As shown in FIG. 3, the lateral end sections 38a, b of the outer beam profile 20 that are disposed at opposing ends of the central section 24 are void of the reinforcing insert 22. The lateral end sections 38a, 38b, however, undergo less bending stress than the central section 24 due to the support to the outer beam profile 20 provided by the crush cans 14 at the lateral end sections 38a, b. Thus, the reinforcement provided by the reinforcing insert 22 is not provided at the lateral end sections 38a, 38b. It is understood that the structural beam 12 may be longer in additional examples and that the impact location may vary from a central section in other implementations on the vehicle 100. In one alternative, the reinforcing insert 22 may extend greater than a half of the length of the outer beam profile 20. For example, where the structural beam 12 is used as a battery tray side member, the reinforcing insert 22 may extend the entire length of the outer beam profile 20 so that the entire beam is consistently reinforced. In another alternative, the reinforcing insert 22 may comprise two or more separate portions of the outer beam profile length, such as, for example, where a crush can is centrally disposed, in addition to being places near the ends of the reinforcement beam. The reinforcing insert 22 may be present in two positions along the length of the reinforcement beam separated by a portion proximate a medial crush can where the reinforcing insert 22 is absent. Referring to FIG. 4, the structural beam 12 is shown from an oblique perspective to illustrate and exemplary implementation of the relative placement and proportions of the reinforcing insert 22 relative to the outer beam profile 20.

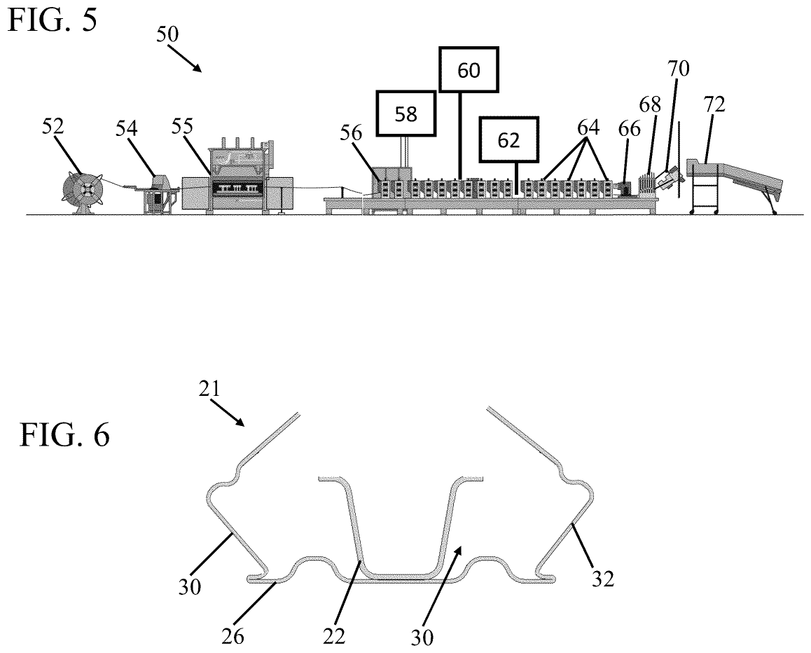

The structural beam 12 may be formed by a roll-forming processing line where the reinforcing insert 22 is disposed within the outer beam profile 20 during the roll-forming of the outer beam profile 20. FIG. 5 illustrates an exemplary roll-forming manufacturing line 50. A sheet material, such as a sheet metal material, is supplied to the manufacturing line from a coil 52. The material may be processed through a straightener or coil joiner 54 to straighten, flatten or join the material supplied from the coil 52. The material may also be processed through a pre-piercer 55 before entering the roll-forming steps of the process. Successive rolls 56 deform the flat sheet material into the desired profile shape. Mandrels (not shown) may also be employed to maintain the shape of the profile during certain process steps. One or more controllers 58 may be in communication with the process equipment to control the successive operations. One or more heaters/annealers 60 may be included to heat treat the sheet material before or after certain process steps, such as where tighter bends are imparted to the sheet material.

At a point in the roll-forming process, the reinforcing insert 22 may be introduced to the sheet material before the outer profile 20 is completed. One exemplary implementation of a partial profile 21 is illustrated is FIG. 6, where the partial profile includes a front wall portion 26, a top wall portion 30 and bottom wall portion 32. The hollow interior area 44 is substantially formed and bounded by the partial profile 21. The insert placement 62 may be a manual process or may be performed automatically by a robotic tool, such as a pick-and-place robot. In other alternatives, an automated dispenser or other suitable mechanism can be used to dispose the reinforcing insert 22 in the partial profile 21. The reinforcing insert 22 itself may be roll-formed in a separate roll-forming process. In other alternatives, the reinforcing insert 22 may be press forged, extruded, pultruded, or formed by another suitable process.

Once placed, the roll-forming process of the outer profile 20 may be continued through additional rolls 64 until the final profile is obtained. At one or more stages of the process, a welder 66, such as a resistive spot welder, inductive welder, laser welder or the like may be provided. In one example, a laser welder may be provided to secure the reinforcing insert 22 in place in the partial profile 21. Alternatively, a resistive spot welder may be used to secure the reinforcing insert 22. In one exemplary implementation, the reinforcing insert 22 may be disposed in the partial profile 21 and welded into place using the same automatic tool, such as a robotic arm including a manipulator to grip and place the reinforcing insert 22 and a welder to secure it once placed. An inductive welder may be used to join the free ends 67 of the partial profile 21 to form the rear wall portion 28.

Once the outer profile 20 has been formed in the sheet material and welded, the process may continue through sweep station 68 to impart a curvature or arc along the longitudinal length and a cutoff device 70 to separate the individual structural beam 12 from the sheet material supply. Such a curved shape or sweep may generally conform the structural beam to the package space permitted by the vehicle design. The curved shape may have a consistent radius of curvature along the length of the structural beam, or in additional examples may have a varied radius of curvature at different sections of the length, such as a greater curvature (and effectively a smaller radius of curvature) at the lateral end sections of the beam. In certain applications, such as a battery tray side member, the structural beam may be rectilinear along its entire length. Finished structural beams 12 may be gathered in a runoff table 72. FIG. 5 presents an exemplary implementation of a roll-forming process and is not intended to be limiting. Steps of the process as described may be performed in alternative orders or in multiple or fewer iterations. Additionally, the process may be performed in multiple discrete processes rather than in a continuous process as suggested. Further alternatives are contemplated to be possible without departing from the scope of the present disclosure.

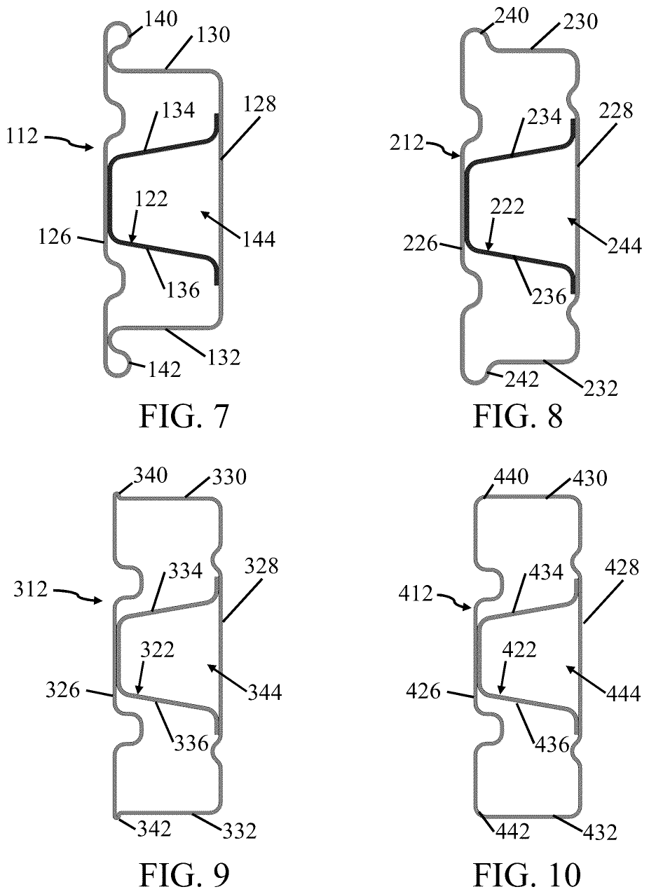

The structural beam 12 is illustrated in FIGS. 2-4 where the upper and lower flanges 40, 42 are tight bends at the junction of the front wall portion 26 with the top and bottom wall portions 34, 36, where the sheet material is folded back on itself, referred to as zero-thickness offset (“0t”) bends. This is not intended to be limiting and other alternatives are contemplated, for example, as illustrated in FIGS. 7-10. In FIG. 7, a first alternative structural beam 112 is illustrated having bulbous upper and lower flanges 140, 142 where the top and bottom wall portions 130, 132 extend to abut the front wall portion 126. The first alternative structural beam 112 also illustrates an example implementation where the ribs 37 are absent from the rear wall portion 128. In such an alternative, the ends of the upper and lower walls 134, 136 of the reinforcing insert may be free within the hollow interior area 144, may abut the rear wall portion 128, or may be welded in place to the rear wall portion 128. In FIG. 8, a second alternative structural beam 212 is illustrated having bulbous upper and lower flanges 240, 242 where the upper and lower wall portions 230, 232 do not extend to the front wall portion 226.

Reduced length 0t bends are shown in upper and lower flanges 340, 342 on the third alternative structural beam 312 in FIG. 9. The reduced length 0t bends, as in FIG. 9 may extend for about one or two times the material thickness above and below the top and bottom wall portions 330, 332 respectively. In a representative example, the length of the upper and lower flanges 40, 42 of the structural beam 12 may extend for about four to eight times the material thickness above and below the top and bottom wall portions 30, 32 respectively. In other examples, the flanges may extend less or greater distance beyond the top and bottom walls of a structural beam. In some alternatives, the upper flange and lower flange may extend by different distances. In still further alternatives, upper and lower flanges may be absent, such as is illustrated in FIG. 10 with the fourth alternative structural beam 412. The front wall portion 426 may transition directly to the top wall portion 430 and the bottom wall portion 432 the bend radius 440, 442 is dictated, for example, by the sheet material thickness.

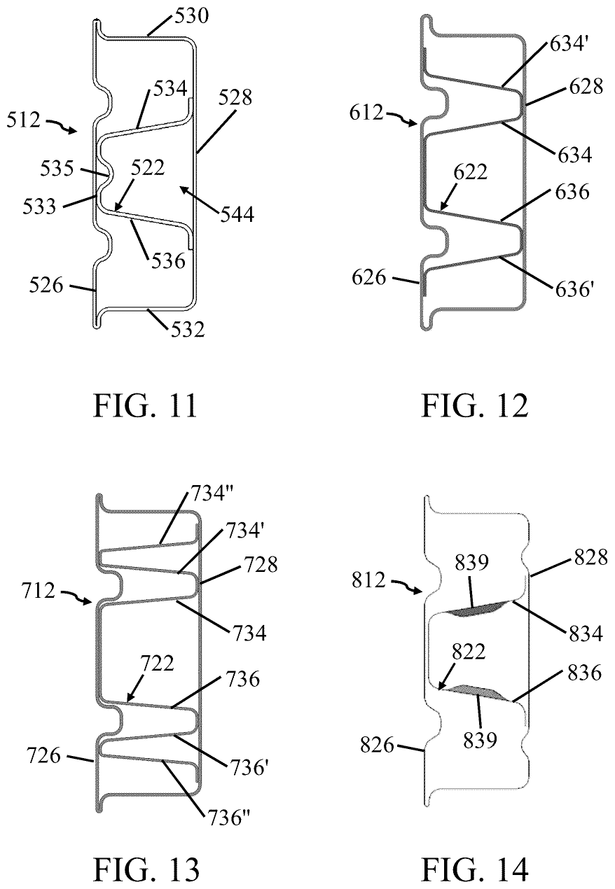

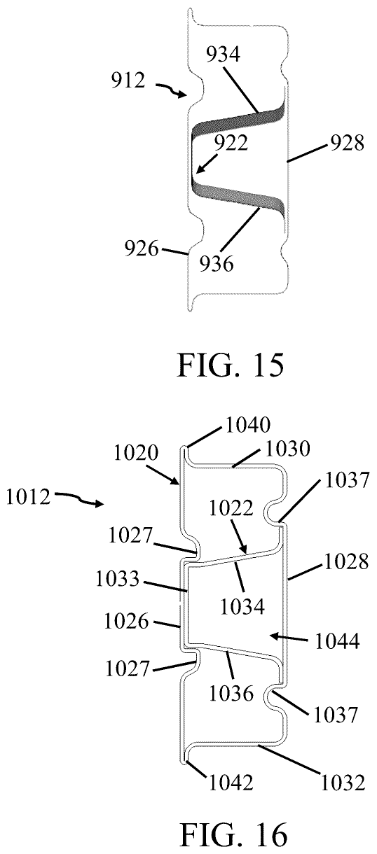

Referring now to FIGS. 11-15, additional exemplary implementations of structural beams are provided illustrating alternative implementation of reinforcing inserts. In FIG. 11, a fifth alternative structural beam 512 is illustrated where the reinforcing insert 522 includes an intermediate wall 533 extending between the upper wall 534 and lower wall 536 and having a rib 535 formed therein. The rib 535 may provide additional strength of the reinforcing insert 522. In FIGS. 12 and 13, the reinforcing inserts 622, 722 include additional shear walls 634, 634′, 636, 636′, 734, 734′, 734″, 736, 736′, 736″ extending between the respective front wall portions 626, 726 and rear wall portions 628, 728. Increasing the number of shear walls further reinforces the rigidity of the structural beams, and may allow for the user of a thinner wall material as the reinforcing insert to achieve a higher beam strength. In FIG. 14, the reinforcing insert 822 includes embossments 839 disposed at points along the length of the upper wall 834 and lower wall 836. In FIG. 15, the reinforcing insert 922 includes corrugated upper and lower walls 934, 936 having wave-like aspects. The illustrated alternative features of the reinforcing inserts of FIGS. 11-15 serve to provide additional strength to the structural beams and can be used, singly, or in various combinations to obtain greater resistance to deformation while using thinner sheet material thicknesses. Obtaining high strength performance from thinner sheet materials reduces part weight, and processing energy demands during manufacturing.

Referring now to FIG. 16, a tenth exemplary structural beam 1012 is illustrated. The structural beam 1012 includes an outer beam profile 1020 and a reinforcing insert 1022 that reinforces a central section of the structural beam 1012 between two opposing longitudinal end sections where the reinforcing insert 1022 is absent. The reinforcing insert 1022 is disposed in a hollow interior area 1044 of the structural beam 1012 and includes an upper wall 1034 and a lower wall 1036 separated by an intermediate wall 1033. The intermediate wall 1033 is disposed adjacent the front wall portion 1026. The upper wall 1034 and the lower wall 1036 each extend between the front wall portion 1026 and the rear wall portion 1028. The upper wall 1034 and lower wall 1036 each include extensions that curve outwardly.

The outer beam profile 1020 defines an elongated hollow body having a longitudinal length and including a front wall portion 1026 and a rear wall portion 1028. The front wall portion 1026 and rear wall portion 1028 are connected by a top wall portion 1030 and bottom wall portion 1032. At the junction of the front wall portion 1026 and the top and bottom wall portions 1030, 1032 there is provided upper and lower flanges 1040, 1042 respectively, each flange 1040, 1042 formed as a 0t bend. The front wall portion 1026 includes ribs 1027 formed in the front wall portion 1026. The ribs 1027 may aid in locating the reinforcing insert 1022 in the hollow interior area 1044. The rear wall portion 1028 includes ribs 1037 formed in the rear wall portion 1028. The ribs 1037 may assist in locating the reinforcing insert 1022 in the hollow interior area. The ends of the upper wall 1034 and lower wall 1036 may extend adjacent the rear wall portion 1028 and abut the ribs 1037. In the tenth exemplary structural beam, the outer beam profile 1020 positively engages the reinforcing insert 1022 along the intermediate wall 1033, bounded by the ribs 1027 along the front wall portion 1026, and at the ends of the upper and lower walls 1034, 1036 at the ribs 1037 along the rear wall portion 1028. In this way, the reinforcing insert 1022 can be retained in place relative to the outer beam profile 1020 without welding or other retention means.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A structural beam for a vehicle, the structural beam comprising:
a roll-formed outer beam profile having an elongated hollow body formed from a sheet material, the hollow body having a front wall portion and a rear wall portion extending along a length defined between a first end and a second end of the hollow body; and
a reinforcing insert disposed along a central section of the reinforcement beam between first and second lateral end sections, the reinforcing insert having an upper wall and a lower wall that each extend between the front wall portion and the rear wall portion of the outer beam profile.

2. The structural beam of claim 1, wherein the reinforcing insert is disposed in the outer beam profile during the roll-forming process.

3. The structural beam of claim 2, wherein the reinforcing insert further comprises an intermediate wall disposed between the upper wall and the lower wall, and wherein the intermediate wall is adjacent the front wall portion of the outer beam profile.

4. The structural beam of claim 3, wherein the intermediate wall of the reinforcing insert is coupled to the front wall portion of the outer beam profile by welding.

5. The structural beam of claim 1, wherein the central section has a first length, the first and second lateral end sections having respective second and third lengths, and wherein the first length is less than a sum of the second and third lengths.

6. The structural beam of claim 1, wherein the upper wall of the reinforcing insert portion extends rearward and upward at an angle of greater than 70° relative to the front wall portion.

7. The structural beam of claim 1, wherein the outer beam profile comprises a top wall portion and a bottom wall portion, the top wall portion and the bottom wall portion extending between the front wall portion and the rear wall portion.

8. The structural beam of claim 7, further comprising an upper flange at a junction of the front wall portion and the top wall portion.

9. The structural beam of claim 1, wherein the upper and lower walls of the reinforcing insert divide an interior volume of the hollow body to form a plurality of elongated hollow areas.

10. A bumper reinforcement beam configured to be supported by crush cans at a vehicle frame, the bumper reinforcement beam comprising:
a roll-formed outer beam profile having an elongated hollow body formed from a sheet material, the hollow body having a front wall portion and a rear wall portion extending along a length defined between a first end and a second end of the hollow body; and
a reinforcing insert disposed along a central section of the hollow body between first and second lateral end sections, the reinforcing insert having an upper wall and a lower wall that each extend between the front wall portion and the rear wall portion of the outer beam profile,
wherein the reinforcing insert is disposed in the outer beam profile during roll-forming.

11. The bumper reinforcement beam of claim 10, wherein the reinforcing insert further comprises an intermediate wall disposed between the upper wall and the lower wall.

12. The bumper reinforcement beam of claim 11, wherein the intermediate wall is adjacent the front wall portion of the outer beam profile.

13. The structural beam of claim 12, wherein the intermediate wall of the reinforcing insert is coupled to the front wall portion of the outer beam profile by welding.

14. The bumper reinforcement beam of claim 10, wherein the central section has a first length, the first and second lateral end sections having respective second and third lengths, and wherein the first length is less than a sum of the second and third lengths.

15. The bumper reinforcement beam of claim 10, wherein the upper wall of the reinforcing insert portion extends rearward and upward at an angle of greater than 70° relative to the front wall portion, and wherein the lower wall of the reinforcing insert extends rearward and downward at an angle of less than 90° relative to the front wall portion.

16. The bumper reinforcement beam of claim 10, wherein the outer beam profile comprises a top wall portion and a bottom wall portion, the top wall portion and the bottom wall portion extending between the front wall portion and the rear wall portion, and wherein the rear wall portion comprises an attachment surface that is adapted for attachment to crush cans.

17. The bumper reinforcement beam of claim 16, further comprising an upper flange at a junction of the front wall portion and the top wall portion.

18. A method of forming a structural beam for a vehicle, the method comprising:
roll-forming a partial profile;
inserting a reinforcing insert into the partial profile; and
roll-forming the partial profile including the reinforcing insert into an outer beam profile of a structural beam for a vehicle, the structural beam having an elongated hollow body.

19. The method of claim 18, wherein the outer beam profile comprises an elongated hollow body formed from a sheet material, the hollow body having a front wall portion and a rear wall portion extending along a length defined between a first end and a second end of the hollow body.

20. The method of claim 19, wherein the reinforcing insert disposed along a central section of the outer beam profile between first and second lateral end sections thereof, the reinforcing insert having an upper wall and a lower wall that each extend between the front wall portion and the rear wall portion of the outer beam profile.
